(19) United States
(12) Patent Application Publication
(10) Pub. No.: US 2026/0151795 A1
(43) Pub. Date: Jun. 4, 2026

(54) Resonator-Boosted Micromachined Ultrasonic Transducers

(71) Applicant: Northeastern University, Boston, MA (US)

(72) Inventors: Luca COLOMBO, Boston, MA (US); Gabriel GIRIBALDI, Cambridge, MA (US); Bernard HERRERA, Cambridge, MA (US); Pietro SIMEONI, Boston, MA (US); Matteo RINALDI, Boston, MA (US)

(21) Appl. No.: 18/706,848

(22) PCT Filed: Dec. 15, 2022
(86) PCT No.: PCT/US2022/052975

§ 371 Date: May 2, 2024

Related U.S. Application Data
(60) Provisional application No. 63/289,940, filed on Dec. 15, 2021.

(51) Int. Cl. B06B 1/02

(52) U.S. Cl. CPC B06B 1/0292; B06B 1/0238; B06B 2201/51; B06B 2201/55; B06B 2201/76

(57) ABSTRACT

A resonator-boosted ultrasonic transducer device is provided for communication of ultrasonic signals. The device employs a micromachined ultrasonic transducer (MUT), such as a piezoelectric MUT (pMUT) or capacitive MUT (cMUT), and a matching network in electrical communication with the MUT. The matching network employs a microelectromechanical (MEMS) resonator having a working frequency selected to increase a voltage difference across electrodes of the MUT. The matching network is connected in series between the MUT and input source circuitry for transmission of outgoing ultrasonic signals. The matching network is connected between the MUT and load impedance circuitry to increase voltage from the MUT during reception of incoming ultrasonic signals. The matching network can be selected to configure the frequency of bandwidth of the device as desired for a particular application.

### CROSS REFERENCE TO RELATED APPLICATIONS

This application claims benefit under 35 U.S.C. § 119(e) of U.S. Provisional Application No. 63/289,940, filed on 15 Dec. 2021, entitled “Resonator-Boosted Micromachined Ultrasonic Transducers”, the entirety of which is hereby incorporated by reference.

### STATEMENT REGARDING FEDERALLY SPONSORED RESEARCH OR DEVELOPMENT

This invention was made with government support under Grant Numbers 1618731, 1726512 and 1763964 awarded by the National Science Foundation. The government has certain rights in the invention.

### BACKGROUND

Within the field of microelectromechanical (MEMS) devices, ultrasonic transducers have been investigated for a wide range of applications such as intra-body communication, imaging, wireless power transfer, Internet of Things (IoT) node links, and more. Micromachined ultrasound transducers (MUTs) can be divided into capacitive (cMUTs) and piezoelectric (pMUTs) according to their transduction mechanism. cMUT performance has a strong dependence on the applied bias voltage and on the capacitor gap, and it comes with a high fabrication complexity. On the other hand, pMUTs do not require a bias voltage and can rely on a relatively simple fabrication process. These advantages are combined with recent advancements in thin-film machining and improvements in piezoelectric film properties. Because of this, pMUTs have gathered attention as candidates to replace or complement the commercially available bulk piezoelectrically actuated ultrasound transducers, especially in low-power applications.

### SUMMARY

The present technology provides an ultrasonic transducer device that can improve performance of a micromachined ultrasonic transducer (MUT) in MUT-based communication links. Some embodiments of the technology can enable frequency reconfigurability of the MUT. The technology employs a matching network (MN) including at least a microelectromechanical (MEMS) resonator and having a working frequency ranging between any pair of resonance frequencies, antiresonance frequencies, or resonance and antiresonance frequencies of the MUT, and including endpoints of the range. The working frequency is selected to increase a voltage difference across electrodes of the MUT. By using a high-quality factor (Q) MEMS resonator, a substantial increase in a MUT-based receiver (Rx) sensitivity can be achieved at the cost of a reduced bandwidth. The out-of-band boosted response can be significantly higher than what is achieved by the standalone MUT's sensitivity. Thus, the system peak sensitivity can be set by the MN resonance, independently of the MUT's center frequency. In some embodiments, by multiplexing different MNs, it is possible to reconfigure the operation of the MUT. By loading the MEMS resonator-based MN (MRMN) with different resistors, the trade-off between sensitivity and bandwidth (BW) can be tuned. The MUT can be a piezoelectric MUT (pMUT) or a capacitive MUT (cMUT).

Further features of the technology include the following:
1. An ultrasonic transducer device for transmitting and/or receiving ultrasonic signals comprising:
   a micromachined ultrasonic transducer (MUT) comprising a membrane suspended over a cavity in a substrate, and electrodes in communication with the membrane; and
   a matching network (MN) in electrical communication with the MUT, the matching network comprising at least a microelectromechanical (MEMS) resonator and having a working frequency selected to increase a voltage difference across the electrodes of the MUT.
2. The device of feature 1, wherein the working frequency of the MN is a resonance frequency or an antiresonance frequency of the MUT, or a frequency between any pair of resonance and antiresonance frequencies of the MUT.
3. The device of feature 1 or 2, wherein the MN has multiple working frequencies.
4. The device of feature 1, wherein the working frequency of the MN is selected to range between any pair of resonance and antiresonance frequencies of the matching network.
5. The device of any of the preceding features, further comprising:
   input source circuitry for inputting an electromagnetic signal to the MUT for transduction;
   wherein the matching network is connected between the MUT and the input source circuitry to increase acoustic pressure of the outgoing ultrasonic signal transmitted from the MUT
6. The device of feature 5, wherein the working frequency of the matching network is selected to generate increased acoustic pressure within the MUT for transmission of the ultrasonic signal.
7. The device of any of features 5-6, wherein the working frequency of the matching network is selected to increase a voltage build up on the static capacitance of the MUT to increase acoustic pressure for transmission of the ultrasonic signal.
8. The device of any of features 5-7, wherein the matching network is connected in series between the MUT and the input source circuitry for transmission of the outgoing ultrasonic signal.
9. The device of any of the preceding features, further comprising:
   load impedance circuitry for receiving an electromagnetic signal transduced by the MUT;
   wherein the matching network is connected between the MUT and the load impedance circuitry to increase voltage from the MUT during reception of the incoming ultrasonic signal.
10. The device of feature 9, wherein the working frequency of the MEMS resonator is selected to boost voltage generated across the electrodes of the MUT for reception.
11. The device of any of features 9-10, wherein the working frequency of the MEMS resonator is selected to allow signals inside or outside a natural bandwidth of the MUT to be transduced.
12. The device of any of features 9-11, wherein the working frequency of the MEMS resonator is selected to create a high impedance node to increase current flow to the load impedance circuitry.
13. The device of any of features 9-12, wherein the matching network further includes one or more resistors, in communication with the MEMS resonator, selected to increase a bandwidth of electromagnetic signals transduced from incoming ultrasonic signals.
14. The device of feature 13, wherein the one or more resistors are tunable to adjust the bandwidth.
15. The device of features 13 or 14, wherein the matching network includes a switch operable to select one of the resistors to adjust the bandwidth.
16. The device of any of features 9-15, wherein the matching network is connected in parallel between the MUT and the load impedance circuitry for reception of the incoming ultrasonic signal.
17. The device of any of the preceding features, wherein the MEMS resonator of the matching network has a quality factor at least 100.
18. The device of any of the preceding features, further comprising a further matching network comprising a further MEMS resonator having a different working frequency, and a switch in communication with the matching network and the further matching network, the switch operable to select one of the matching network and the further matching network for electrical connection to the MUT.
19. The device of any of the preceding features, further comprising:
   input source circuitry for inputting an electromechanical signal to the MUT for transduction and transmission as an outgoing ultrasonic signal;
   load impedance circuitry for receiving an electromechanical signal transduced from an incoming ultrasonic signal by the MUT; and
   a plurality of matching networks, each comprising a MEMS resonator, the plurality of matching network comprising at least a first matching network connected in parallel between the MUT and the input source circuitry and at least a second matching network connected in series between the MUT and the load impedance circuitry.
20. The device of feature 19, further comprising a switch connected to the plurality of matching networks and operable to select between the first matching network for reception of the incoming ultrasonic signal and the second matching network for transmission of the outgoing ultrasonic signal.
21. The device of any of the preceding features, wherein the MUT is a piezoelectric micromachined ultrasonic transducer.
22. The device of any of the preceding features, wherein the MUT is a capacitive micromachined ultrasonic transducer.
23. The device of any of the preceding features, wherein the membrane of the MUT includes one or more materials selected from the group consisting of aluminum nitride, doped aluminum nitride, scandium-doped aluminum nitride, chromium-doped aluminum nitride, lithium niobate, lead-zirconate-titanate, and silicon.
24. The device of any of the preceding features, wherein the MEMS resonator includes one or more materials selected from the group consisting of quartz, aluminum nitride, doped aluminum nitride, scandium-doped aluminum nitride, chromium-doped aluminum nitride, lithium niobate, and silicon.
25. The device of any of the preceding features, wherein the MEMS resonator is a bulk piezoelectric resonator, a thin-film piezoelectric resonator, or a capacitively actuated resonator.
26. The device of any of the preceding features, wherein the MUT and the MEMS resonator are fabricated on a single chip.
27. The device of any of the preceding features, wherein the MUT has a natural frequency of about 1 kHz to about 100 MHz.
28. The device of any of the preceding features, wherein the matching network increases amplification of the voltage difference across the electrodes of the MUT by at least two times compared to a MUT lacking the matching network.
29. The device of any of the preceding features, further comprising an array of micromachined ultrasonic transducers, each micromachined ultrasonic transducer connected to the matching network.
30. A plurality of devices of any of the preceding features, wherein the plurality of devices is arranged in an array.
31. The device of any of the preceding features, configured for use in a fluid medium.
32. The device of any of the preceding features, configured for use in air.
33. The device of any of the preceding features, configured for use in a liquid medium.
34. The device of any of the preceding features, configured for use underwater.
35. The device of any of the preceding features, configured for use in a solid medium.
36. The device of any of the preceding features, configured for use in biological tissue.
37. The device of any of the preceding features implanted in a human or non-human mammalian body.
31. A method of communication using ultrasonic signals, comprising:
   providing one or more devices of any of the preceding claims; and
   transmitting and/or receiving ultrasonic signals with the one or more devices.
38. A method of fabricating the ultrasonic transducer device of any of the preceding features, comprising:
   fabricating the matching network with a determined working frequency for the MEMS resonator; and
   connecting the matching network to the MUT.
39. The method of feature 38, wherein the matching network and the MUT are fabricated on a same substrate.
40. The method of feature 38, wherein the matching network and the MUT are fabricated separately and integrated after fabrication.
41. The method of feature 38, further comprising fabricating the MUT and the matching network on a single chip.
42. A method of producing the ultrasonic transducer device of any of features 1-37, comprising determining a working frequency for the MEMS resonator.
43. The method of feature 42, further comprising:
   fabricating the matching network with the determined working frequency; and
   connecting the matching network to the MUT.

### DESCRIPTION OF THE DRAWINGS

FIG. 1A is a schematic illustration of embodiments of boosted transmission (Tx) and reception (Rx) ultrasonic transducer devices, depicting the electrical equivalent circuit of a pMUT with a matching network in electrical connection with the pMUT in the transmission TX case (upper diagram) and a matching network in electrical connection with the pMUT in the reception case (lower diagram).

FIG. 1B is a schematic illustration of the embodiments of FIG. 1A showing the MEMS resonator of the matching network in series with the MUT in the TX case (upper diagram) and in parallel with the MUT in the Rx case (lower diagram).

FIG. 1C is a Butterworth-Van Dyke model of a piezo-MEMS resonator employed in a matching network.

FIGS. 2A-2D show normalized voltage gain Gv compared to an unmatched pMUT when (2A-2B) an inductor or (2C-2D) a resonator is employed as MN, for the (2A-2C) Tx and (2B-2D) Rx architectures. The pMUT's simulated parameters are C₀=7 pF and fs=2 MHz, while the resonators C₀=7 pF, kt²=10% and fs=2 MHz.

FIG. 3A shows an optical microscope top view of a Sc_{0.36}Al_{0.64}N pMUT described herein.

FIG. 3B shows a drawing of the cross-section of the pMUT of FIG. 3A.

FIGS. 4A-4B show a printed circuit board in its (4A) front and (4B) rear views. The employed 10×1 linear array is highlighted in FIG. 4A, while the input signal and the two employed MNs are shown in FIG. 4B.

FIGS. 5A-5D illustrate experimental and simulated admittance Y₁₁ curves for (5A) the pMUT array alone, (5B) the series of the array and the inductor, and (5C) the series of the array and the resonator. The insets show a schematic of the tested circuit, with the MN element resonating with the array static capacitance and the on-chip parasitic capacitance. In FIG. 5D, an mBVD fitting of the employed commercial MEMS resonator is shown, with the relevant extracted parameters in the inset.

FIGS. 6A-6B illustrate (6A) measured displacement on a DHM of the center of one of the pMUTs of the array when used in the Tx configuration, showing the 3.5× and 11× gain with respect to an unmatched array and (6B) a-posteriori simulated gains function of the frequency for the case of the inductor and resonator as MNs.

FIG. 7A illustrates a test setup for testing performed in a water tank.

FIG. 7B is a graph of the results showing voltage vs. time for a pMUT alone and a pMUT+resonator tested with the setup in FIG. 7A.

FIG. 8 is a micrograph of a bonded pMUT array with a scanning electron microscope (SEM) zoom-in to a device's cross-section showing the membrane and the cavity.

FIG. 9 is a schematic representation of an underwater experimental setup, including a water basin, a boosted Rx, a COTS hydrophone used as broadband Tx, a signal generator and an oscilloscope.

FIGS. 10A-10C illustrate an experimental demonstration of pMUTs reconfigurability. By applying a sine wave a f=fᵢₙ sine-amplitude-modulated at f=f_{mod}, the received spectrum shows 3 peaks, at fᵢₙ and at fᵢₙ±f_{mod}. When applying the signal to a standalone pMUT array (FIG. 10A), the three peaks have low amplitude since the frequencies are out of band for the array. Nevertheless, when connecting the two MRMNs, one at a time, there is a significant (>20 dB) boost in the Rx sensitivity at a fᵢₙ+f_{mod} (FIG. 10B) and fᵢₙ-f_{mod} (FIG. 10C), respectively.

FIG. 11A shows voltage rain on the bRx normalized to the case of the standalone pMUT as function of frequency for different loading resistors.

FIG. 11B shows gain and BW values for different loading resistors, highlighting the tradeoff.

### DETAILED DESCRIPTION

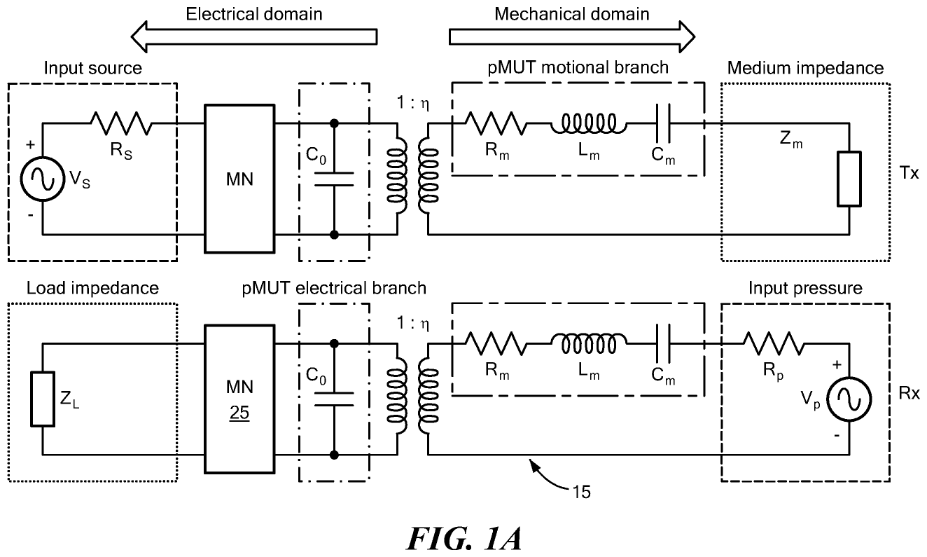

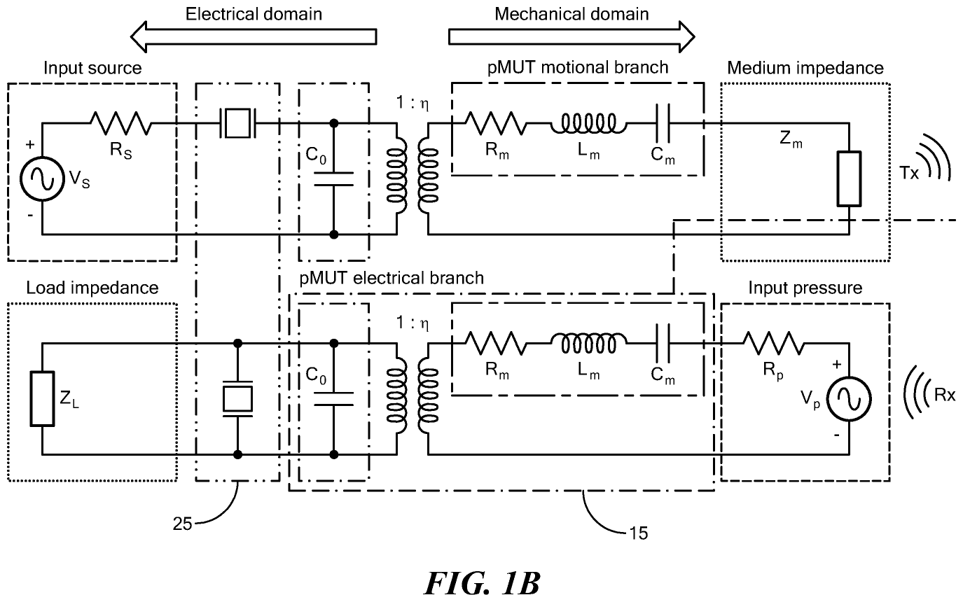

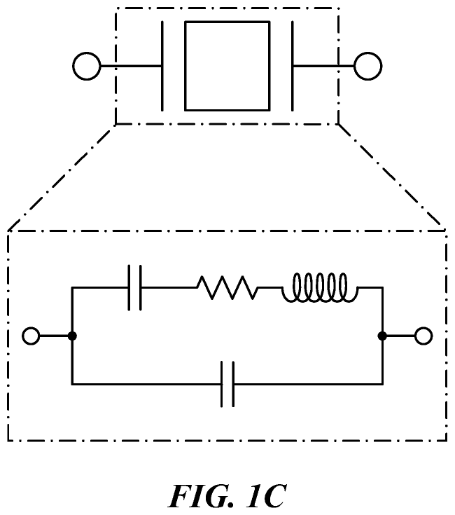

FIGS. 1A and 1B illustrate embodiments of an ultrasonic transducer device that can be used in a communication link for transmission and/or reception of ultrasonic signals. The device includes a micromachined ultrasonic transducer (MUT) 15 and a matching network (MN) 25 in electrical communication with the MUT. MUTs can act both as acoustic transmitters (Tx) and receivers (Rx). FIGS. 1A and 1B depict the system architectures of two embodiments employing a pMUT, in which the connection between the electrical and the mechanical domain of the pMUT is represented by an equivalent transformer to represent the transduction from the electrical to the mechanical domain. In both figures, the top diagram depicts the MN connected to the MUT in series for transmission (Tx), and the bottom diagram depicts the MN connected to the MUT in parallel for reception (Rx).

The MUT, which can be a piezoelectric MUT (pMUT) or a capacitive MUT (cMUT), includes a suspended membrane or plate, and electrodes in electrical communication with the membrane for transduction of an outgoing electromagnetic signal to an ultrasonic signal or of an incoming ultrasonic signal to an electromagnetic signal. The matching network includes at least a microelectromechanical (MEMS) resonator and has a working frequency ranging between one or more resonance frequencies and one or more antiresonance frequencies, the working frequency selected to increase a voltage difference across the electrodes of the MUT.

The present technology increases the performance of the MUT, or an array of MUTS, by integrating the MEMS-based matching network (MN) in the transducer's architecture. The MN facilitates the recovery of the reactive power accumulated between the MUT electrodes, thus passively boosting the voltage across them. The higher voltage increases the pressure that the device can generate when used as transmitter and enhances its sensitivity when used as receiver.

pMUTs are useful for ultrasound-based communication given their small footprint and excellent performance in air, water, and intra-body applications. This class of devices offers design flexibility, simple fabrication, and their operating frequency (fs). range can be as wide as 20 kHz to 20 MHz. However, once the devices are fabricated, their spectral response is fixed, as it depends on the geometrical dimensions of the device, such as the piezoelectric layer thickness and the membrane diameter.

By way of further explanation, a pMUT can be modeled by a modified Butterworth-Van Dyke (mBVD) equivalent circuit, in which an electrical branch describing the capacitance between the electrodes is in parallel with a motional branch, which describes the plate dynamics with an RLC circuit (FIGS. 1A and 1B). Because of damping from the surrounding medium, the motional branch is characterized by a higher impedance than the electrical capacitance. Therefore, most of the energy in the system flows through the electrical branch in the form of reactive power. In the present technology, MEMS resonators used as MNs can be employed to recover this power and passively boost the voltage generated across the MUT's electrodes. FIG. 1C illustrates a Butterworth-Van Dyke equivalent circuit of a MEMS resonator.

The matching network with MEMS resonator of the present technology provides an advantage over the use of prior art off-chip inductors and pass-band filters to match the MUT capacitance, because the limited quality factor of the inductors considerably reduces the gain that can be attained with better performing elements and requires the use of off-chip MN components. In contrast, the MEMS resonators provide very high-quality factors and more compact form factors, and can be directly integrated with the MUTs, thus reducing the parasitic capacitance introduced by off-chip interconnections and the overall die size.

In the Tx case, a goal is to maximize the voltage across the MUT's electrodes resonating out their static capacitance with the inductive MN element. At the resonance frequency of the system, the voltage generated on the MUTs is progressively increased. Typically, the steady-state level is determined by the quality factor of the inductive element used to match the MUTs capacitance. In the Rx case, assuming voltage-sensing is used to detect the incident ultrasound, the system sensitivity is increased at its anti-resonance, when the transducer array and the parallel MN constitute a high impedance node so that more current can flow in the load impedance. Both in the Rx and Tx cases, the voltage increase occurs independently from the resonance frequency of the MUT's motional branch, although it will be appreciated that optimal boosting can be achieved when the system's working-frequency is aligned with the MUTs resonance.

As noted above, an electrical model of the MRMN-boosted Tx and Rx is depicted in FIGS. 1A-1C, referencing a pMUT. The pMUT dynamics are represented by an RLC circuit (Rₘ, Lₘ, and Cₘ) that describes the device's behavior in the mechanical domain (motional branch) and by a static capacitance (C₀) in the electrical domain. The transduction from one domain to the other is carried out by a transformer of ratio set by the transduction coefficient η. The Tx and Rx cases differ in how the MRMN is interfaced with the MUT: it is connected in series to the MUT (or MUT array) in the Tx, and in parallel to it in the Rx.

### A. Boosted Tx

In an ultrasound Tx, an input electrical signal is converted into acoustic waves which are radiated into the surrounding medium, which is described in the equivalent circuit by the radiation impedance ZM in the mechanical domain. Due to the relatively poor electromechanical coupling (kₜ²) of flexural resonators (typically <1%) most of the electrical energy provided to the system flows into the electrical capacitance C₀. While more energy flows into the mechanical branch at the natural resonance (the resonance in the absence of a driving force) of the pMUT plate, the limited quality factor of flexural resonators (especially in water) provides limited increase in sensitivity. In a resonator-boosted Tx (bTx), instead, given an MRMN of resonance frequency f_{sMN}, the MEMS resonator acts as a high-Q inductor resonating out the static capacitance of the pMUT (connected in series) at a frequency close to f_{sMN}. In this way, a voltage build-up across C₀ is possible, charging the pMUT's electrical capacitance with a time constant that is proportional to the MN quality factor. This mechanism allows the bTx to generate more acoustic pressure than a conventional Tx per unit input voltage, or alternatively to transmit at across the same range with a lower amplitude input signal. Since the quality factor of the pMUT is typically very low, the transmission improvement is not affected by the pMUTs natural frequency, and is mainly determined by the center frequency of the MRMN.

### B. Boosted Rx

In a pMUT-based Rx, incoming ultrasound sets the transducer in motion, which converts the sound wave into an electrical signal to be delivered to its load (Z_{L}). In a resonator-boosted Rx (bRx), to maximize the voltage build-up across the pMUT electrodes, the MN is connected in parallel to the transducer. When the MRMN operates in its inductive region, it acts as a high-Q inductor generating a parallel resonant circuit with the static capacitance. In this way, a high impedance node is created, allowing much more current to flow into the Rx's load, thus increasing the system's sensitivity. As for the bTx case, the increase in sensitivity generated by the introduction of MRMN is not tied to the position of the natural frequency of the pMUT, but it is rather set by the antiresonance frequency of the MRMN. Frequency reconfigurability can therefore be achieved by multiplexing multiple resonators to the same pMUT array.

In embodiments of an ultrasonic transducer device according to the technology herein, any suitable MEMS resonator can be used. In some embodiments, the resonator can be a piezoelectric resonator. In some embodiments, the MEMS resonator can be a bulk piezoelectric resonator or a thin-film piezoelectric resonator. In some embodiments, the resonator can be a capacitively actuated resonator. In some embodiments, the material for the resonator can be quartz, aluminum nitride, doped aluminum nitride, scandium-doped aluminum nitride, chromium-doped aluminum nitride, lithium niobate, or silicon, or combinations thereof.

The matching network is selected with one or more desired working or operating frequencies, selected to increase a voltage difference across the electrodes of the MUT. In some embodiments, the working frequency can be a resonance frequency of the MUT, an antiresonance frequency of the MUT, or can range between any pair of resonance and antiresonance frequencies of the MUT. In some embodiments, the working frequency can range between any pair of resonance and antiresonance frequencies of the MEMS resonator of the matching network, to enable operation outside the bandwidth of the MUT. The working frequency can range between any pair of resonance and/or anti-resonance frequencies, depending on the application, as described further below. The device or network used as the MN can have multiple resonance frequencies. The device can have N resonance frequencies and anti-resonance frequencies, and the MN can be operated at any working frequency between any frequency of resonance and anti-resonance, i.e., the working frequency can fall in any of these ranges.

In embodiments of an ultrasonic transducer device according to the technology herein, any suitable MUT can be used as the transducing component. In some embodiments, the MUT can be a piezoelectric MUT (pMUT). In some embodiments, the MUT can be a capacitive MUT (cMUT). In some embodiments, the material for the membrane or plate of the MUT can be aluminum nitride, doped aluminum nitride, scandium-doped aluminum nitride, chromium-doped aluminum nitride, lithium niobate, lead-zirconate-titanate, or silicon, or combinations thereof. The MUT can have any shape and any dimensions, depending on the application. In some embodiments, the membrane or plate can be suspended over a cavity in a substrate. In some embodiments, the electrodes can be connected on opposite sides of the membrane or plate.

When used for transmission of an outgoing ultrasonic signal, the matching network is connected in series between the MUT and the input source circuitry to increase acoustic pressure of the outgoing ultrasonic signal transmitted from the MUT. In some embodiments, the working frequency can be a resonance frequency of the MUT selected to generate increased acoustic pressure within the MUT for transmission of the ultrasonic signal. In some embodiments, the working frequency can be a resonance frequency of the MUT selected to increase a static capacitance voltage build up in the MUT to increase acoustic pressure for transmission of the ultrasonic signal.

When used for reception of an incoming ultrasonic signal, the matching network is connected in parallel between the MUT and a load impedance circuitry to increase voltage from the MUT during reception of the incoming ultrasonic signal. In some embodiments, the working frequency can be an antiresonance frequency of the MEMS resonator selected to boost voltage generated across the electrodes of the MUT for reception. In some embodiments, the working frequency can be an antiresonance frequency of the MUT selected to allow signals outside a natural bandwidth of the MUT to be transduced. The working frequency can be an antiresonance frequency of the MUT selected to create a high impedance node to increase current flow to the load impedance circuitry.

In some embodiments, the matching network can include one or more resistors, in communication with the MEMS resonator, selected to increase a bandwidth of electromagnetic signals transduced from incoming ultrasonic signals. In some embodiments, the resistors can be tunable to adjust the bandwidth. The device can include a switch operable to select one of the resistors to adjust the bandwidth.

The technology described herein can be extended from the architectural-level MN-boosting to increase MUT-based transceivers' performance to embodiments that enabling their frequency reconfigurability. In some embodiments, the device can include a further matching network comprising a further MEMS resonator having a different working frequency. A switch in communication with the matching network and the further matching network, can select one of the matching network and the further matching network for electrical connection to the MUT. In this way, the device can be configured to operate at different frequencies.

In some embodiments, the device can include both a transmitter and a receiver in communication with the MUT, for transmitting and receiving ultrasonic signals. The device can include input source circuitry for inputting an electromechanical signal to the MUT for transduction and transmission as an outgoing ultrasonic signal, and load impedance circuitry for receiving an electromechanical signal transduced from an ultrasonic signal by the MUT. A plurality of matching networks can be included, each comprising a MEMS resonator. At least a first matching network is connected in parallel between the MUT and the input source circuitry and at least a second matching network is connected in series between the MUT and the load impedance circuitry.

A MUT boosting technique employing a MEMS-based MN as described herein was demonstrated on a 10 linear Sc_{0.36}Al_{0.64}N pMUT array operating at 2 MHz, described further below. Starting from the use of a limited-performance inductor as MN, the transition to a high-gain, narrow-band passive voltage amplification using a MEMS resonator was simulated for the cases of Tx and Rx system architectures. The MN-boosting was experimentally demonstrated using commercial off-the-shelf inductor and crystal resonator, showing a membrane displacement increase of 3.5× and 11×, respectively, from 20 nm/V to 70 and 225 nm/V when using the devices as Tx. The experimental results were corroborated by a-posteriori ADS simulations.

Although the experimental demonstration was performed on ScAlN-based devices, the MN-boosting technique is material-agnostic, being suitable for performance enhancements of systems built on different piezoelectric layers. Moreover, because the boosting is related to the static capacitance of the MEMS devices, the same concept can be applied to cMUTs.

The validity of a circuital-level explanation of the MN-boosting mechanisms was verified through two sets of experiments involving a boosted Rx operating in underwater conditions. The experiments demonstrated: 1) a significant 11× increase in sensitivity of an underwater Rx compared to a standalone pMUT one, 2) pMUT's frequency reconfigurability by connecting the array with a MEMS-resonator MN, and 3) the gain-BW trade-off, verified by loading the MN with a set of COTS resistors.

This demonstration indicates that the technology can provide a realization of IoT node front-ends able to reconfigure their operation and adjust their data rate as function of the distance from the node(s) they are communicating with.

In some embodiments, the matching network can increase amplification of the voltage difference across the electrodes of the MUT by at least 2 times compared to a MUT lacking the matching network.

In some embodiments, the MEMS resonator of the matching network has a quality factor, Q, of at least 100. The quality factor is a ratio of the energy stored versus the energy dissipated per cycle in the resonator and can be estimated by dividing the resonance frequency by the bandwidth, where the bandwidth is the full bandwidth at half the maximum resonant frequency.

As used herein a MEMS resonator can be a resonator that is 1000 micrometers or less in one or more dimensions and can be fabricated using any semiconductor fabrication technology.

Dimensional tolerances can be ±0.5%, ±1%, ±2%, ±5%, ±10%, ±15%, or ±20%.

In some embodiments, the device can be configured for use in a fluid medium. In some embodiments, the device can be configured for use in air. In some embodiments, the device can be configured for use in a liquid medium. In some embodiments, the device can be configured for use underwater. In some embodiments, the device can be configured for use in biological tissue. In some embodiments, the device can be implanted in a human or non-human mammalian body. In some embodiments, the device can be configured for use in a solid medium.

In some embodiments, a method of communication using ultrasonic signals can be provided, by providing one or more devices as described herein and transmitting and/or receiving ultrasonic signals with the one or more devices. In some embodiments, a method of fabricating the ultrasonic transducer device can be provided by fabricating the matching network with a determined working frequency for the MEMS resonator; and connecting the matching network to the MUT. In some embodiments, the MUT and the matching network can be fabricated on a single chip.

The technology also provides a method of communication using ultrasonic signals. In some embodiments, the method can include providing one or more devices of any of the preceding claims; and transmitting and/or receiving ultrasonic signals with the one or more devices.

The technology can include a method of fabricating the ultrasonic transducer device as described herein. In some embodiments, a method can include fabricating the matching network with a determined working frequency for the MEMS resonator; and connecting the matching network to the MUT. In some embodiments, the matching network and the MUT can be fabricated on a same substrate. In some embodiments, the matching network and the MUT can be fabricated separately and integrated after fabrication. In some embodiments, the MUT and the matching network can be fabricated on a single chip. In some embodiments, a method of fabrication can include determining one or more working frequencies for the MEMS resonator, fabricating the matching network with the one or more determined working frequencies; and connecting the matching network to the MUT.

The present technology provides a variety of features. For example, the amplification technique is completely passive, so no additional power consumption is necessary to boost the MUTs performance. The technology is applicable for both transmission and sensing use cases. The technology is applicable to both capacitive and piezoelectric MUTs, the two main transducer types used in commercial products. The technology provides for aggressive filtering due to the inherently high Q of microacoustic resonators, which would reduce the impact of interference and intermodulation on the communication channel.

The present technology provides a variety of advantages and improvements over previous technology. For example, the technology provides a higher receiver sensitivity when used in a sensing configuration. The technology provides higher power output when used in a transmission configuration. The technology provides a reduced area covered by the MUTs (easier integration, lower costs). The technology provides reduced on-chip parasitic capacitances, since the resonator can compensate for them as well, not only for the MUT static capacitance.

The present technology has a variety of uses. For example, it can be used for ultra low-power ultrasound wake-up receivers. It can be used for passive amplification for underwater ultrasound beacons. It can be used for high-efficiency power transfer for patches and implanted medical devices

### EXAMPLES

### Example 1

An MN-boosting system on a 36%-doped ScAlN linear pMUT array was fabricated. Circuit simulations were also performed, both when using the devices as receivers and transmitters. In both cases, the results were simulated using either an inductor or a MEMS resonator to match the pMUT's capacitance. The experimental results obtained for the transmitter case were obtained by using commercial off-the-shelf components to implement the MN building block.

More particularly, the device was validated experimentally using a 10-element scandium aluminum nitride (Sc_{0.36}Al_{0.64}N) pMUT linear array operating in transmission mode at 1.93 MHz over-the-air. An off-chip 138 μH inductor and a commercial off-the-shelf ceramic resonator were utilized as MNs to passively increase the pMUTs' displacement by a factor of 3.5 and 11, from 20 nm/V to 70 and 225 nm/V, respectively.

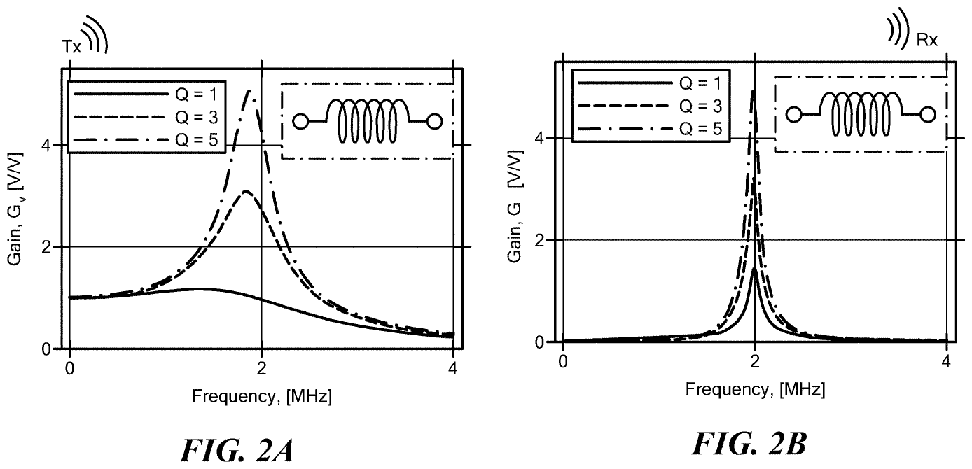

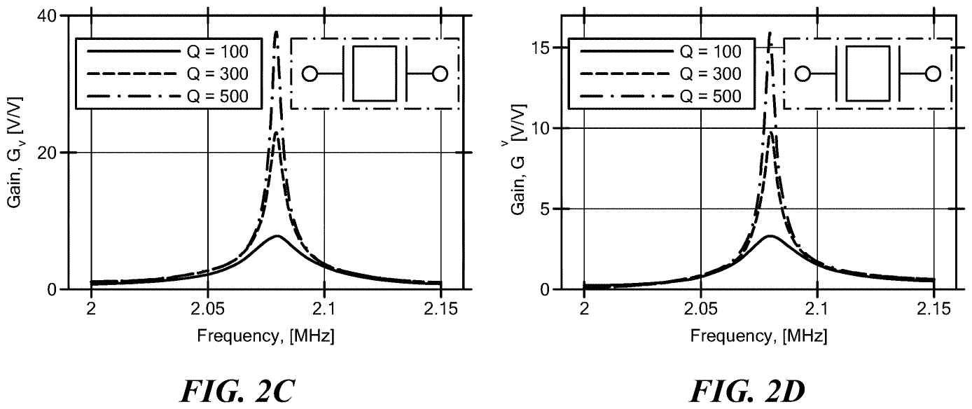

FIGS. 2A-2D shows the simulated normalized voltage gains on the pMUT when MNs with conservative performance were included in the design. The simulations were carried out in Advanced Design System (ADS). The pMUT array resonance frequency was chosen to be 2 MHz, the quality factor (Q) was set to 20 and the static capacitance (C₀) to 7 pF, to simulate a linear array of 10 pMUTs with a static capacitance of each single device of 700 fF. For the inductor, quality factors of 1, 3, and 5 were simulated. For the resonator case, a C₀ of 7 pF, an electromechanical coupling coefficient (kₜ²) of 10% and Qs of 100, 300, and 500 were used. It was observed that the inductor provided a moderate gain while maintaining a large bandwidth. On the other hand, the resonator significantly boosted the pMUTs' voltage, but narrowed down the bandwidth proportionally to the loaded Q. Therefore, the MN topology can be chosen according to the needs of the specific application.

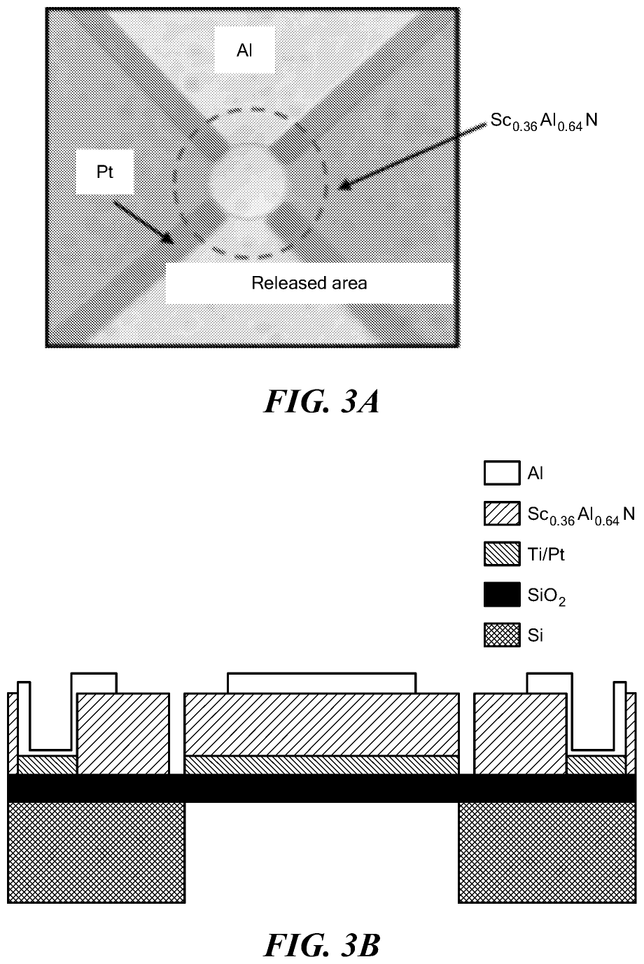

To demonstrate the functionality of the MN-boosting, a 10×1 linear array of pMUTs was used. It was fabricated starting on a 300 μm thick <100> double-side polished 4″ silicon wafer, onto which 1 μm of silicon dioxide (SiO₂) was thermally grown. 140 nm of Pt were then sputtered on a Ti adhesion layer (˜5 nm). The piezoelectric Sc_{0.36}Al_{0.64}N was co-sputtered with a target thickness of 500 nm. The desired concentration was achieved with 900 W DC+100 W RF power applied to the Al target, while 710 W DC were applied to the Sc target, with a procedure as described in Giribaldi et al. 2021 (G. Giribaldi, M. Pirro, B. H. Soukup, M. Assylbekova, L. Colombo, and M. Rinaldi, “Compensation of Contact Nature-Dependent Asymmetry in the Leakage Current of Ferroelectric ScAl1-x N Thin-Film Capacitors,” in Proceedings of the IEEE International Conference on Micro Electro Mechanical Systems (MEMS), 2021, vol. 2021-Janua. doi: 10.1109/MEMS51782.2021.9375451); and in Pirro et al. 2021 (M. Pirro, B. Herrera, M. Assylbekova, G. Giribaldi, L. Colombo, and M. Rinaldi, “Characterization of Dielectric and Piezoelectric Properties of Ferroelectric AlScN Thin Films,” in Proceedings of the IEEE International Conference on Micro Electro Mechanical Systems (MEMS), 2021, vol. 2021-Janua. doi: 10.1109/MEMS 51782.2021.9375427). For the top electrodes, 100 nm Al were deposited and patterned via lift-off, while the back-cavity was formed via deep reactive ion etching (DRIE) on the backside of the wafer. FIG. 3A shows an optical microscope top view of the fabricated Sc_{0.36}Al_{0.64}N pMUT, and a drawing of the cross section of the structure is shown in FIG. 3B.

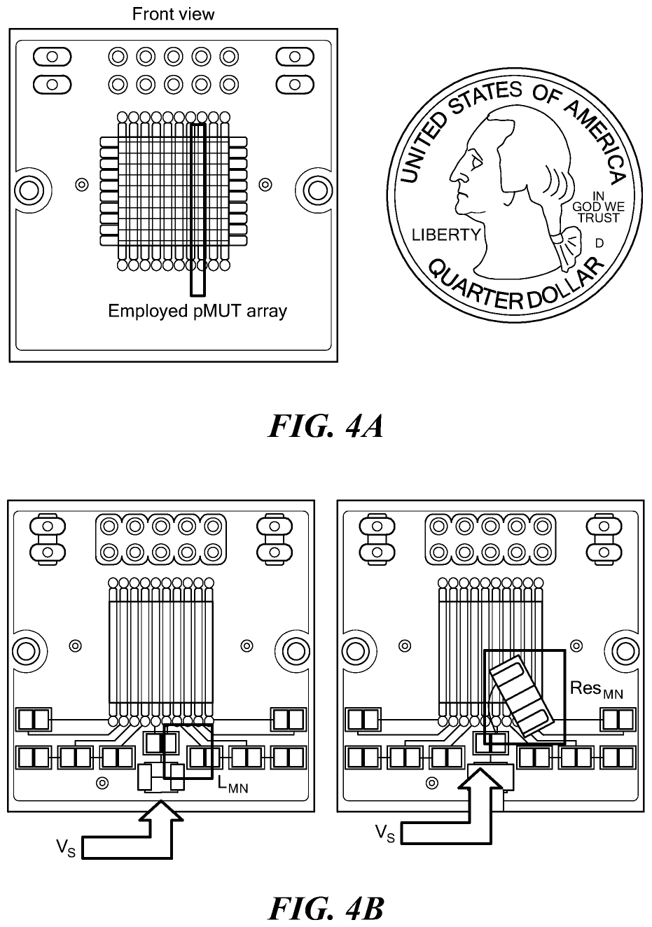

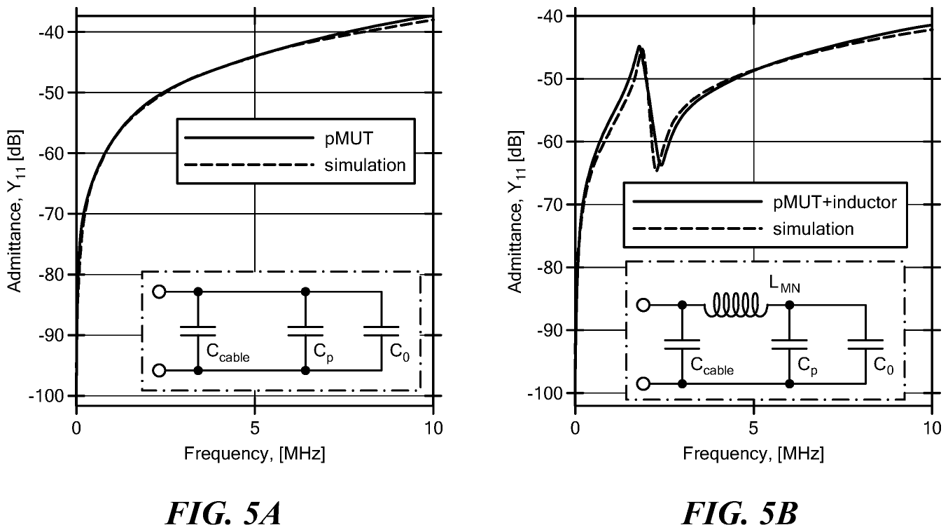

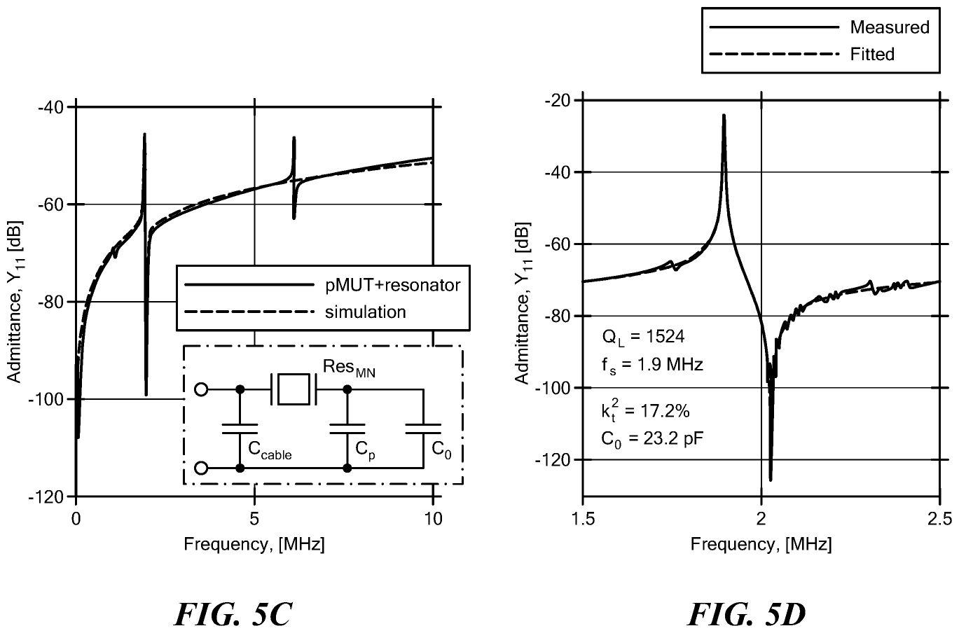

The pMUT array was then mounted on a printed circuit board (PCB) for testing as shown in FIG. 4A. The frequency response of the array connected to the PCB is depicted in FIGS. 5A-5D, graph a. The expected C₀ coming from the pMUTs was ˜7 pF, while the measured value was 75 pF due to on-chip parasitic capacitance (C₀+Cₚ in the inset of FIG. 5A). A micro-SMA cable with capacitance C_{cable}=131 pF was then used to connect to the testing setup, giving an overall capacitance Cₜₒₜ=206 pF. To validate the boosting technique for the Tx architecture, an inductor (LMN=138 μF) was placed in series with the MEMS array, showing the frequency response of FIG. 5B, where the MN element was resonating out not only the pMUTs capacitance, but the sum of C₀ and Cₚ, indicating how this approach can help mitigate the effect of parasitic capacitive loading.

When connecting a commercial performing ceramic MEMS resonator (MURATA CSTCC2M00G53A-R0), the system showed the frequency response of FIG. 5C, with a sharp, high-gain resonant peak. The standalone resonator response is shown in FIG. 5D, along with its fitting parameters.

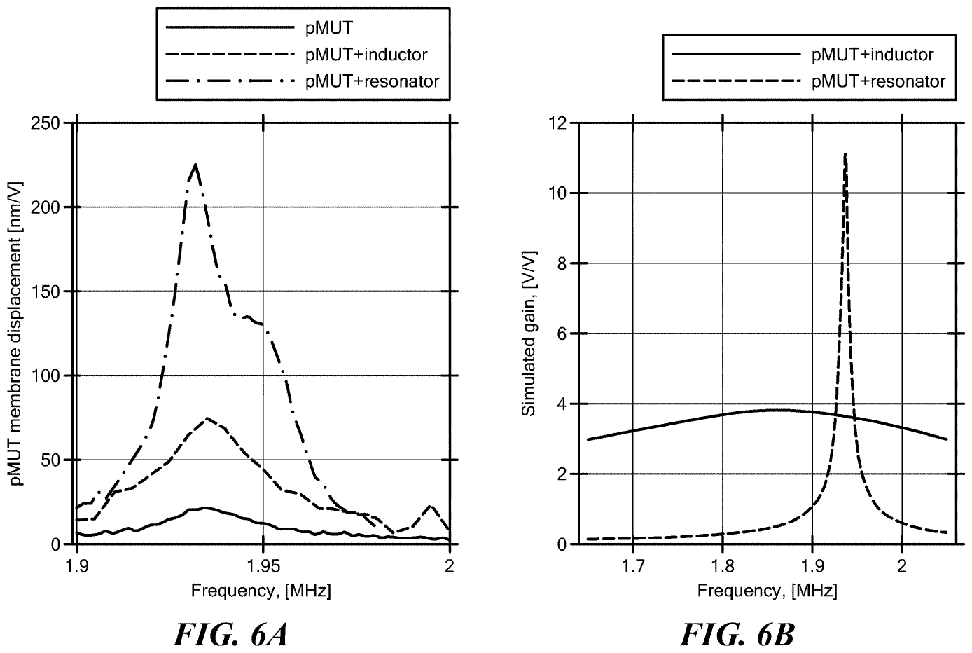

The curves of FIGS. 5A-5C were fitted with ADS, while the resonator frequency response of FIG. 5D was fitted with a multi-modified Butterworth-Van Dyke (mmBVD) model. To verify the effectiveness of the MN-boosting, the membrane displacement of the pMUTs in the array was measured with a Lyncée Tech Digital Holographic Microscope (DHM), and the results are shown in FIG. 6A.

The membrane displacement was boosted by a factor of 3.5 and 11 when the pMUT array was connected to the inductor and to the resonator, respectively, going from 20 nm/V to 70 and 225 nm/V. Using experimentally extracted relevant values for the pMUT array, the inductor and the resonator, the expected gains were simulated in ADS and found to closely match the experimental results (FIG. 6B).

While the boosted membrane displacement constitutes a sufficient proof for the Tx case, the over-the-air measurement setup did not allow to demonstrate the Rx architecture. This is because: (i) the attenuation of the acoustic signal at the relatively high frequency of 2 MHz was too high to allow for a transmitted signal detection and (ii) a capacitive coupling between the Tx and the Rx existed and covered the acoustic coupling.

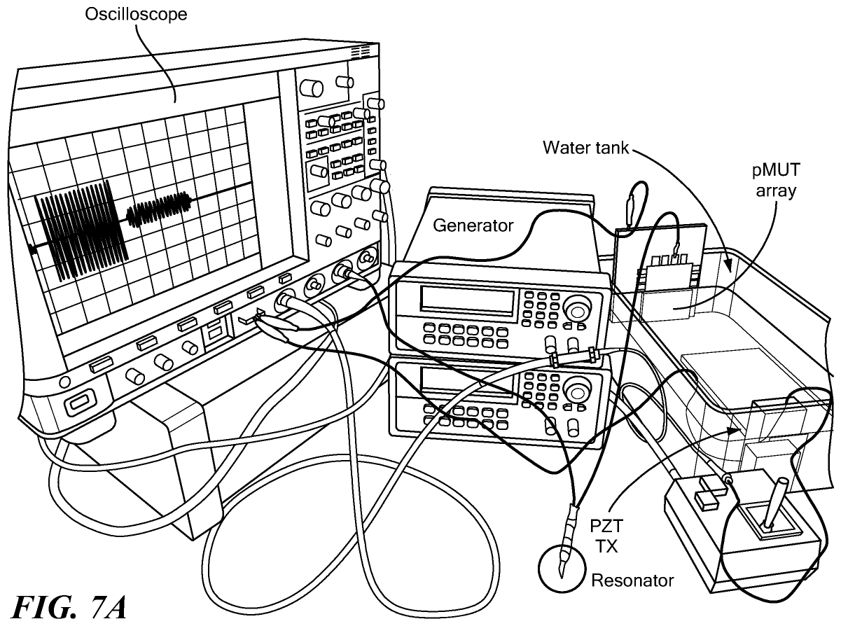

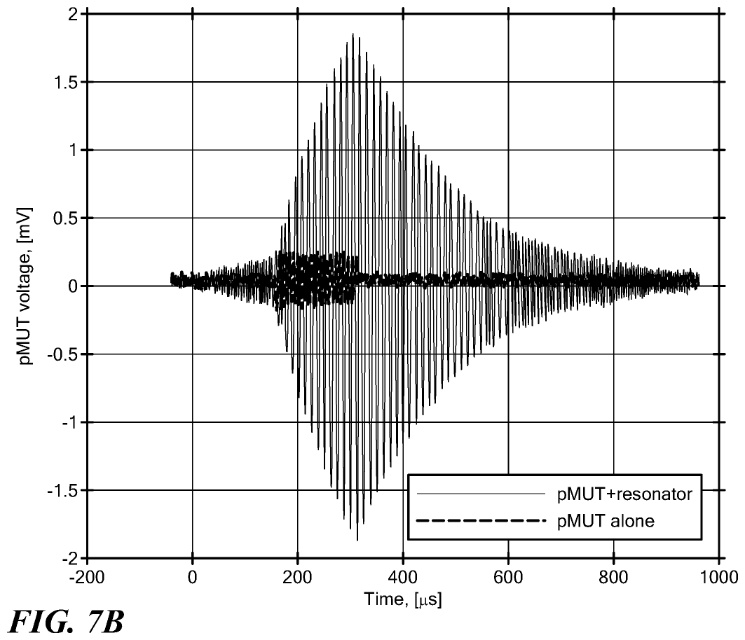

Receiver (Rx) underwater tests were performed to further assess the MN-boosted system's capabilities. The tested pMUTs had a resonance at 700 kHz in water. Given the lack of immediate availability of commercial resonators at ˜700 kHz, the system was tested out-of-band at 1.919 MHz. The tests were performed in a water tank using the setup shown in FIG. 7A. The transmitter (Tx) was a bulk PZT situated 24 cm removed from the pMUT array. The signal was generated by a waveform generator, and the response was read on an oscilloscope. The results are shown in FIG. 7B. The standalone pMUT array had a response with a peak-to-peak amplitude of 0.38 mV, while the boosted one had 3.72 m V peak-to-peak. Therefore, the resonator MN provided a boost of 9.65-fold (19.69 dB) after the ring-up time.

### Example 2

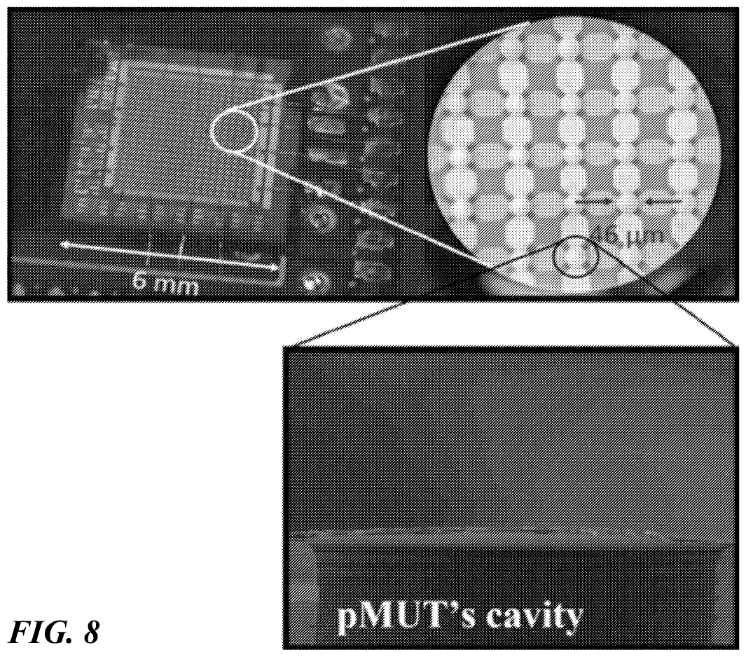

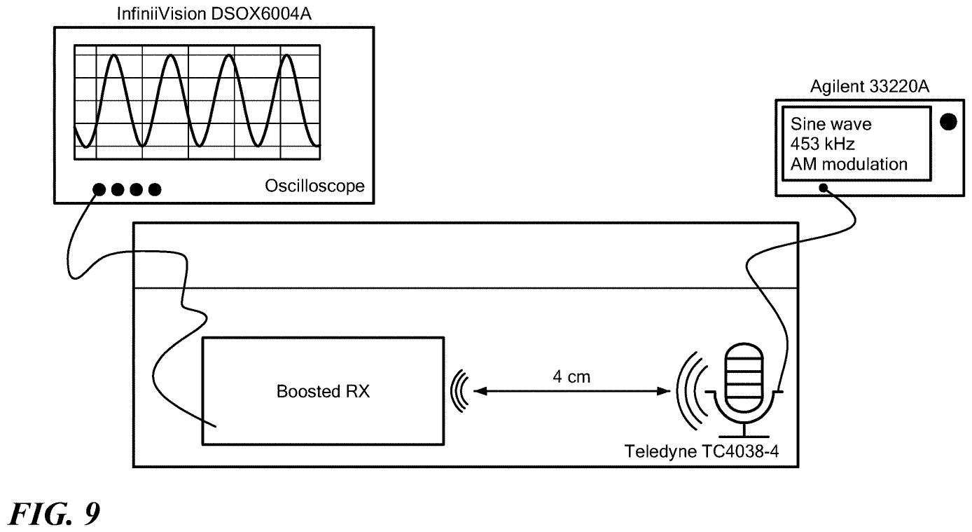

Further experiments were performed on a bRx constituted by a 36% Sc-doped Aluminum Nitride (ScAlN) 20×20 pMUT array. The devices were fabricated as described with respect to Example 1, while the piezo-film was sputtered as in Pirro et al., 2021. COTS MEMS resonators and resistors were used as MRMNs. The natural frequency of the pMUTs in the array was measured at 700 kHz in water. FIG. 8 shows a micrograph of the bonded pMUT array with a scanning electron microscope (SEM) zoom-in to the device's cross-section showing the membrane and the cavity. FIG. 9 shows the underwater testing setup. As shown, the bRx was submerged in water, while a COTS hydrophone (Teledyne TC4038-4) was used as a Tx, emitting a broadband ultrasound spectrum. The Tx was connected to a signal generator (Agilent 33220A) and the bRx to an oscilloscope (Keysight DSOX6004A) in order to record the received signal.

A. pMUT's Reconfigurability

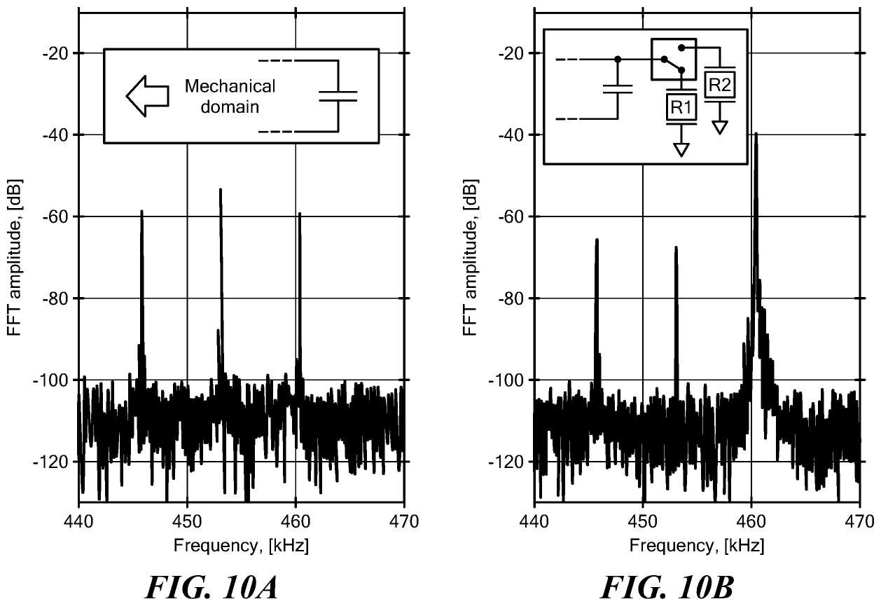

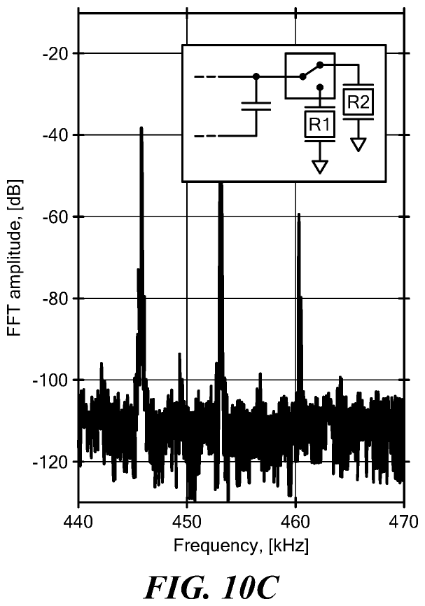

To demonstrate pMUT's reconfigurability, two different MRMNs were selected (R1 and R2), with anti-resonance frequencies fₚ₁=460.1 kHz and fₚ₂=445.9 kHz, respectively. A sine wave at fᵢₙ=453 kHz sine-modulated at f_{mod}=7.1 kHz and was then applied to the Tx, generating the received Fourier spectrum shown in FIG. 10A in absence of the MRMN. As can be observed, there are 3 peaks, at f=fᵢₙ and at f=±f_{mod}, with the peaks standing at approximately the same (low) amplitude given that the 3 frequencies are outside of the pMUTs' 700 kHz natural frequency band. When connecting R1, the spectral response changes to the one of FIG. 10B, with more than 20 dB voltage gain for the frequency fᵢₙ+f_{mod} with respect to the un-boosted case. A similar behavior is observed when connecting the second MRMN (FIG. 10C), also boosting the spectral response of fᵢₙ−f_{mod} by more than 20 dB.

This experiment demonstrates pMUTs' reconfigurability at the architectural level. Moreover, more MNs can be multiplexed, allowing the system to receive on multiple communication channels, one at a time, and benefiting from the increased sensitivity.

### B. Gain-Bandwidth Trade-Off

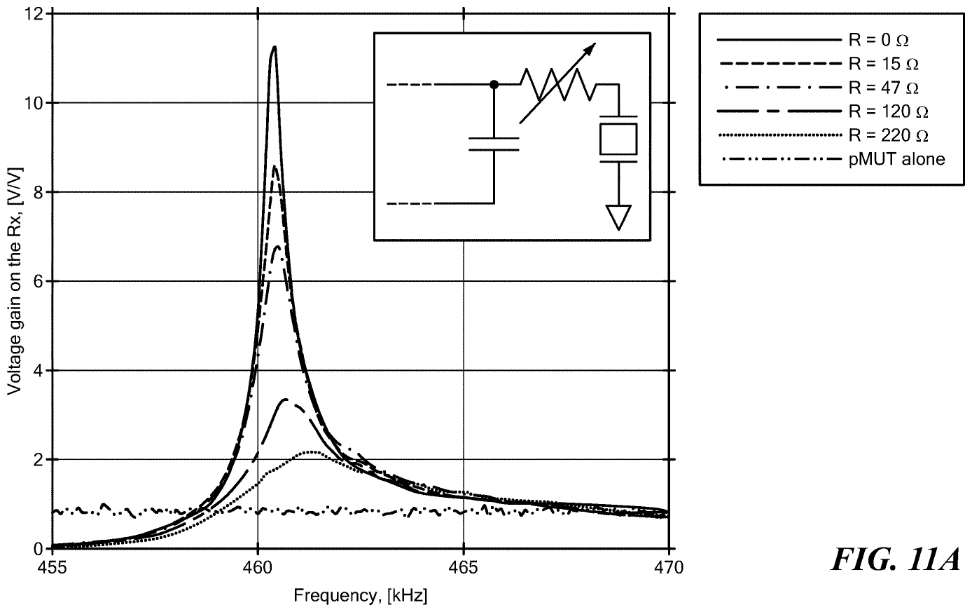

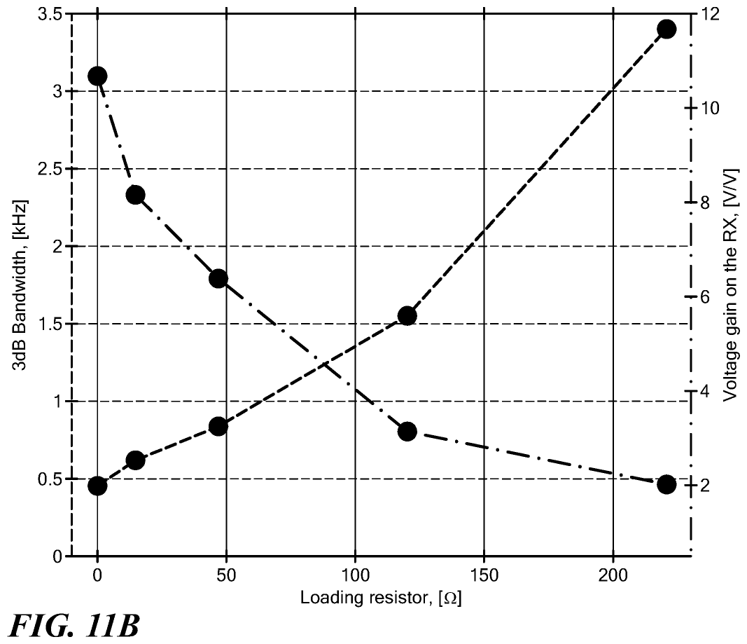

The cost of using a high-Q MRMN to boost the PMUTs response is a narrowing of the system's band. The band decreases proportionally with the system's gain, and therefore with the MN's Q. Nevertheless, the quality factor of the resonator can be artificially reduced by loading it with COTS resistors, trading off the gain magnitude for the bRx's BW. This hypothesis was experimentally verified by connecting the pMUTs array to R1, and selecting different resistance values to load the MN, namely 0, 15, 47, 120, and 220 Ω. The bRx's normalized gain (G) vs. frequency is shown in FIG. 11A, along with the standalone array case. The gain in the case of no resistor, G=11 corresponds to the 20.83 dB boost shown in FIG. 10B. FIG. 11B reports the obtained values of 3 dB BW and normalized voltage gains as a function of the loading resistor, and highlights their proportionality. Passing from a 0 Ω load to a load of 220 Ω, the BW was increased by more than 6 times, while the gain was about 6 times smaller. Nevertheless, the bRx's sensitivity was still twice as much as a conventional un-boosted Rx at the same frequency.

These results demonstrate the second-order trade-off of the boosted systems, allowing a pMUT-based IoT front-end module with a switchable bank of resistors to adjust the BW (i.e. the communication data rate) as a function of the distance with the node with which it is communicating, or as function of the required received signal to noise ratio.

As used herein, “consisting essentially of” allows the inclusion of materials or steps that do not materially affect the basic and novel characteristics of the claim. Any recitation herein of the term “comprising,” particularly in a description of components of a composition or in a description of elements of a device, can be exchanged with “consisting essentially of” or “consisting of.”

To the extent that the appended claims have been drafted without multiple dependencies, this has been done only to accommodate formal requirements in jurisdictions that do not allow such multiple dependencies. It should be noted that all possible combinations of features that would be implied by rendering the claims multiply dependent are explicitly envisaged and should be considered part of the invention.

What is claimed is:

1. An ultrasonic transducer device for transmitting and/or receiving ultrasonic signals comprising:
a micromachined ultrasonic transducer (MUT) comprising a membrane suspended over a cavity in a substrate, and electrodes in communication with the membrane; and
a matching network (MN) in electrical communication with the MUT, the matching network comprising at least a microelectromechanical (MEMS) resonator and having a working frequency selected to increase a voltage difference across the electrodes of the MUT.

2. The device of claim 1, wherein the working frequency of the MN is a resonance frequency or an antiresonance frequency of the MUT, or a frequency between any pair of resonance and antiresonance frequencies of the MUT.

3. The device of claim 2, wherein the MN has multiple working frequencies.

4. The device of claim 1, wherein the working frequency of the MN is selected to range between any pair of resonance and antiresonance frequencies of the matching network.

5. The device of claim 1, further comprising:
input source circuitry for inputting an electromagnetic signal to the MUT for transduction;
wherein the matching network is connected between the MUT and the input source circuitry to increase acoustic pressure of the outgoing ultrasonic signal transmitted from the MUT

6. The device of claim 5, wherein the working frequency of the matching network is selected to generate increased acoustic pressure within the MUT for transmission of the ultrasonic signal.

7. The device of claim 5, wherein the working frequency of the matching network is selected to increase a voltage build up on the static capacitance of the MUT to increase acoustic pressure for transmission of the ultrasonic signal.

8. The device of claim 5, wherein the matching network is connected in series between the MUT and the input source circuitry for transmission of the outgoing ultrasonic signal.

9. The device of claim 1, further comprising:
load impedance circuitry for receiving an electromagnetic signal transduced by the MUT;
wherein the matching network is connected between the MUT and the load impedance circuitry to increase voltage from the MUT during reception of the incoming ultrasonic signal.

10. The device of claim 9, wherein the working frequency of the MEMS resonator is selected to boost voltage generated across the electrodes of the MUT for reception.

11. The device of claim 9, wherein the working frequency of the MEMS resonator is selected to allow signals inside or outside a natural bandwidth of the MUT to be transduced.

12. The device of claim 9, wherein the working frequency of the MEMS resonator is selected to create a high impedance node to increase current flow to the load impedance circuitry.

13. The device of claim 9, wherein the matching network further includes one or more resistors, in communication with the MEMS resonator, selected to increase a bandwidth of electromagnetic signals transduced from incoming ultrasonic signals.

14. The device of claim 13, wherein the one or more resistors are tunable to adjust the bandwidth.

15. The device of claim 13, wherein the matching network includes a switch operable to select one of the resistors to adjust the bandwidth.

16. The device of 9, wherein the matching network is connected in parallel between the MUT and the load impedance circuitry for reception of the incoming ultrasonic signal.

17. The device of claim 1, wherein the MEMS resonator of the matching network has a quality factor at least 100.

18. The device of claim 1, further comprising a further matching network comprising a further MEMS resonator having a different working frequency, and a switch in communication with the matching network and the further matching network, the switch operable to select one of the matching network and the further matching network for electrical connection to the MUT.

19. The device of claim 1, further comprising:
input source circuitry for inputting an electromechanical signal to the MUT for transduction and transmission as an outgoing ultrasonic signal;
load impedance circuitry for receiving an electromechanical signal transduced from an incoming ultrasonic signal by the MUT; and
a plurality of matching networks, each comprising a MEMS resonator, the plurality of matching network comprising at least a first matching network connected in parallel between the MUT and the input source circuitry and at least a second matching network connected in series between the MUT and the load impedance circuitry.

20. The device of claim 19, further comprising a switch connected to the plurality of matching networks and operable to select between the first matching network for reception of the incoming ultrasonic signal and the second matching network for transmission of the outgoing ultrasonic signal.

21. The device of claim 1, wherein the MUT is a piezoelectric micromachined ultrasonic transducer or a capacitive micromachined ultrasonic transducer.

22. The device of claim 1, configured for use in a liquid medium or in biological tissue.

23. A method of communication using ultrasonic signals, comprising:
providing the device of claim 1; and
transmitting and/or receiving ultrasonic signals with the device.

24. A method of fabricating the ultrasonic transducer device of claim 1, comprising:
fabricating the matching network with a determined working frequency for the MEMS resonator; and
connecting the matching network to the MUT.
